(19) United States
(12) Patent Application Publication
(10) Pub. No.: US 2007/0109520 A1
(43) Pub. Date: May 17, 2007

(54) Modular illuminator for a scanning printer

(76) Inventor: Theodore Robert Whitney, Woodland Hills, CA (US)

Correspondence Address: THEODORE R. WHITNEY, #109, 6914 Canby Ave., Reseda, CA, 91335, US

(21) Appl. No.: 11/594,271

(22) Filed: Nov. 7, 2006

Related U.S. Application Data
(60) Provisional application No. 60/737,784, filed on Nov. 17, 2005.

(51) Int. Cl. G03B 27/54

(52) U.S. Cl. 355/67

(57) ABSTRACT

Disclosed herewith is a system and method for building an illuminator for a scanning printer. The design is modular enabling any of a number of different sources to be used with common partial coherence and scanning optics. The illuminated field, moves across the photomask in synchronism with the motion of the scanning printer, preserving telecentricity, entendue and optical distance invariance as it scans.

### REFERENCE TO PRIOR APPLICATION

This invention claims priority from Provisional Application Ser. No. 60/737,784 filed Nov. 17, 2005, and entitled “a Modular Illuminator for a Scanning Printer”.

### FIELD OF THE INVENTION

This invention describes a modular illuminator optical system that will condition and remap the radiation output from various illumination sources and redirect the suitably modified light energy into the optical transfer system of a scanning printer. More particularly this invention uses as an example a modular illuminator which would be suitable for use with a printer such as that described in Whitney “ROLL PRINTER WITH DECOMPOSED RASTER SCAN AND X-Y DISTORTION CORRECTION” U.S. Pat. No. 7,130,020 B2 issued Oct. 31, 2006, hereinafter referred to as Whitney '020, incorporated herein by reference.

### BACKGROUND OF THE INVENTION

Any given scanning printer is employed for a specific exposure purpose and consequently will have specific exposure requirements and a preferred light source. Prior to this invention it has been necessary to design the entire illuminator to accommodate the separate requirements of wavelength, usable f/cone, etc. which may be made necessary by choice of a different light source. Principal among the light sources that are currently used in comparable exposure tools are the excimer laser and the high-pressure mercury or mercury-xenon arc. A need exists for an illuminator that comprises largely common parts, so that when different models of an exposure tool are built, to serve different exposure purposes, the required illuminator can largely be assembled from modular parts that are common to all sources. The exposure tool thereby serves more possible applications, with far less required development expense.

There are fixed limits to the dimensions of any beam that can be utilized by the downstream imaging optics of a scanning printer, hereinafter referred to as the optical transfer system. These limits are set by a geometrical optical constant known in its one-dimensional form as the LaGrange product, or the LaGrange invariant, and in its two dimensional form as the “etendue” or admittance of the system. It is the product of the area of the illuminated field of the optical transfer system multiplied by the solid angle from points in the field to the system limiting aperture. Efficient use of the available source energy requires that the brightest part of the source be used and, as closely as possible, the energy captured from the source not overfill the admittance of the optical transfer system. And to preserve all possible resolution of the photomask object at the format, as seen through the follow-on optical transfer system, the beam at the photomask also should not possess less than the full etendue of the system.

In addition to satisfying the etendue requirement at the end of the illuminator, which is the photomask object plane, the beam is required to have an evenly distributed shape that fills the field stop of the optical transfer imaging optics. At that point the beam must have an f/number, a two dimensional angular divergence and telecentricity that matches the input of the optical transfer imaging optics as well. It must then be scanned across the photomask object in synchronism with the movement of the optical transfer imaging optics, by means of a photomask scanner, while maintaining the above geometry.

It is well-known in the photolithographic art that selective control of the coherence of illuminator light can have positive effects upon the imagery which the printer will produce. It is known that partial or altered coherence, produced by restricting the angular dimensions or the local intensity of the illuminator light in some manner, can produce crisper lines or better resolution. Other aspects of illuminator beams, for example polarization, can sometimes be invoked to produce higher contrast.

The simplest quantitative definition of partial coherence is given by the ratio of the numerical aperture of the illuminator to the numerical aperture of the follow-on imaging system, NAᵢₗₗ/NA_{imag}. However this definition assumes that the two-dimensional acceptance cone of the illuminator is evenly filled by incoming incoherent illumination. Partial coherence effects that may be produced thereafter are assumed to have been obtained only by restricting the outside boundaries of the beam, usually at the illuminator pupil. This approach produces partial coherence as defined above, at the expense of restricting exposure light.

Many other approaches have been taken, however, including occlusion or partial occlusion of the beam in various selected patterns at the illuminator pupil. Other means can also be introduced in particular cases, as for example, in cases where the beam is polarized. In such a case selective polarization rotating means can be used to alter properties of a portion of the illuminating beam, also preferentially introduced at or close to the system pupil.

Phase shifting the beam has relevance only when the incoming beam already has some coherent basis from which the phase can be shifted. Shifting the phase of a portion of an already incoherent beam by π radians, for example, makes no sense, unless the beam is to be compared to itself. If the beam is carrying no information beforehand, it will still be carrying no information, other than relative information, after a portion of it has been shifted in phase. In cases where the incoming light has some initial coherence, the selective adjustment of phase of a portion of the beam may produce an improved result, possibly in combination with selective occlusion of portions of the illuminator pupil.

The illuminated photomask may be considered as a grating. As such it will diffract transmitted illuminator light into various orders which when recombined at the focal plane of the optical transfer system form a resolved image. The finer image detail is carried by the higher diffracted orders, which are diffracted at larger angles, while information describing the broad areas is carried disproportionately by the zero order undiffracted light or by the +/− first orders. Partial or total occlusion of the central area of the illuminator pupil, and consequent suppression of the smaller angles of light in the beam incident on the photomask, is another form of Partial Coherence Control. This enables the partial suppression of zero order and first order light. This disproportionate partial suppression of zero order and first order light in turn emphasizes relatively the higher diffracted orders and enhances the rendition of detail in the format image.

### PRIOR ART

Scanning printers using largely reflective optics often take the form of Offner-like, largely or totally reflective systems, (c.f. U.S. Pat. No. 3,748,015, 4,236,186, Whitney '020, and numbered references 1-6). As a consequence they bring with them not only the advantages but also the problems of ring field optics. The scanning field is arc shaped, a portion of a ring of good resolution centered approximately at the center-line of the primary and secondary mirrors and having an arc radius equal or nearly equal to the system decenter. The illuminating system that precedes it must fill the arc shaped field stop as efficiently as possible.

The problem of creating a ring-shaped field of illumination, from radiation that is generated by a point source was addressed in Ban U.S. Pat. No. 4,294,538 Oct. 13, 1981. Ban invented a system of off-axis reflectors, which together transform the beam from a point source object into an arc of a ring field disposed telecentrically. This beam, in turn, is suitable for illuminating the input field of an Offner-like reflective optical transfer system. In the Ban design an attempt is made to collect and to utilize the rear lobe of the steradiancy emitted from the radiating point source. Shiozawa et al U.S. Pat. No. 5,726,740 solved a similar problem in a slightly different way, producing a full illuminated ring field, starting from a point source (where unfortunately in most cases less than one-half of the ring is needed). Antoni et al, U.S. Pat. No. 6,840,640 solved the problem for point sources in the EUV region, at or less than 193 nm. This solution is not limited to below 193 nm. However their arrangement of mirrors collects only a small angular cone of the emitting source, and for visible or near-UV sources the arrangement is very inefficient in light collection compared to the two design approaches discussed above.

The use of fiber bundles, either coherent or random, to transform beam shapes is well known, given that light is of a wavelength which is able to be transmitted reasonably by the fibers. Fiber bundles are inefficient, at best transforming and transmitting 60-70% of the incident light to the far end. They compare favorably, however, with the efficiencies that may be expected from the alternative methods discussed above.

Examples of different aspects of partial coherence technology are given in Gallatin et al U.S. Pat. No. 6,259,513 or Tsacoyeanes et al U.S. Pat. No. 6,888,615. Still another example appears in Michaloski et al U.S. Pat. No. 5,383,000. See also numbered reference 7. Additionally, some systems provide for the adjustment and also for the measurement of the degree of partial coherence produced in the illuminator, as for example Whitney U.S. Pat. No. 4,936,665, incorporated herein by reference. Whitney '665 also discloses different ways in which occluding and phase reversal aperture zones can be arranged in the pupil of the follow-on Optical Transfer System in order to enhance resolution and improve depth of focus. This latter technique is customarily referred to as apodization.

Scanning printers have always incorporated in their design some method of scanning the mask object, by moving the mask, moving an element of the optical transfer optics, etc. Some also provide for scanning the illumination field across the object field in synchronism with the requirements of the image optics, if the field is large. An example of a scan of that type, carried out over a large two-dimensional field, appears in numbered reference 9. That system keeps all of the optical distances constant throughout the scan, by coordinating the motions of a set of flat mirrors, moved synchronously in two directions.

### SUMMARY OF THE INVENTION

This invention comprises an illuminator for a scanning printer that is comprised of two modules in series. The first module, referred to as the Source Module, is assumed to be different for each source, because of the greatly different requirements of the various possible sources that may be used. The next module, referred to as the Common Module, contains Reflective Relay and Partial Coherence Optics and the Photomask Scanner. This module is designed to be common to all sources.

The modularity of the present illuminator, together with the all-reflective design of the common module, permits radiation of any wavelength from any individual Source Module to be integrated seamlessly into the common elements that comprise the rest of the printer system. This feature broadens the application of the exposure tool, at minimum capital expense. Thus, while no individual application of the illuminator will necessarily have a requirement for more than one source, using this modular approach different exposure tools for different exposure applications do not need to be designed from scratch.

The various sources may be designed into different Source Modules, each with different beam conditioning, which fit seamlessly into the Common Module. An array of Source Modules can be used in different installations, each containing a light source, including but not limited to excimer lasers, gas and ion lasers, high pressure mercury or mercury-xenon lamps, metal-halide arcs, microwave excited sources, xenon short arc lamps, and other laser and diode sources, each fitted with optics that condition that light and shape it to fit the input requirements of the follow-on common module. Some of these possible configurations, among others, are shown in the schematic diagram, FIG. 1.

A principal objective of any configuration of the Modular Illuminator design must be to conserve the light source energy, by assuring that each stage in the transformation and conditioning process is as efficient as is reasonable, within the art. Beam intensity control, shuttering, spectral filtering, speckle suppression, cooling and dumping of excess radiation are conventional functions that are readily incorporated into the individual Source Modules. Excimer laser wavelengths, or indeed any wavelengths below about 330 nm., present special problems with respect to reflectivity, and where an excimer source or a deep UV arc source is used, the reflectivity of all mirrors, throughout the system, must be designed to be high for that wavelength band. The design of a reflector for use in the ultraviolet usually takes the form of a quarter-wave reflective stack.

Use of a pulsed source of whatever type recognizes that each exposed point at the format is the integrated sum of partial exposure received from many source pulses. The source must operate at a pulse rate sufficiently high that no exposure effect of the pulsing can be seen. Thus, in the case of the Whitney '020 printer design configuration, use of a pulsed source operating at 4000 pulses per second is fine, but use of a pulsed source operating at 500 pulses per second might be marginally too slow. A simple calculation shows that, when the Whitney '020 printer is exposing the format at a scanning speed of 20 cm. per second, using a 3 mm. wide exposure field stop, if the source is operating at only 500 pulses per second, each exposed point within the image is the integrated result of only about 7.5 pulses. This can produce a jagged result.

### A BRIEF DESCRIPTION OF THE FIGURES

FIG. 1 Block Diagram of the Modular Illuminator

FIG. 2 Flow Chart of the Light Processing Sequence

FIG. 3 Layout of Laser Optics (Prior Art)

FIG. 4 Wavefront at the final pupil of the Excimer Optics (Prior Art)

FIG. 5 The Common Module, comprising the Reflective Relay, Partial Coherence and Photomask Scanning Optics

FIG. 6 Radiant and Irradiance Patterns of a typical High Pressure Mercury Arc (Prior Art)

FIG. 7 A typical Mercury-Xenon Arc Radiant Spectrum (Prior Art)

FIG. 8 The Metal-Halide Arc Radiant Distribution (Prior Art)

FIG. 9 The Metal-Halide Arc Spectral Distribution (Prior Art)

FIG. 10 Block Diagram showing relation of the modular illuminator to the scanning printer.

### A PREFERRED EMBODIMENT OF THE INVENTION

To illustrate the principle of the modular illuminator, I choose a design example based upon the downstream parameters of the printer described in Whitney '020. The 1-to-1 Offner-like reflective Optical Transfer System of that design has an arc shaped field stop, 84 mm. high, 4 mm. wide. The input optics must be telecentric and have a solid angle of admittance of f/4×f/4. The etendue of the Optical Transfer System in that design, using small angle approximations, is about:
8.4 cm The height of the illuminated input field×0.4 cm The width of the illuminated input field×0.25 rad The angular subtence of the width of the pupil as seen from the input field.×0.25 rad The angular subtence of the height of the pupil as seen from the input field.×π/4 Conversion from a square to a circular pupil =0.165 cm²ster
This is the approximate etendue of the Optical Transfer System, the imaging optical assembly described in Whitney '020.

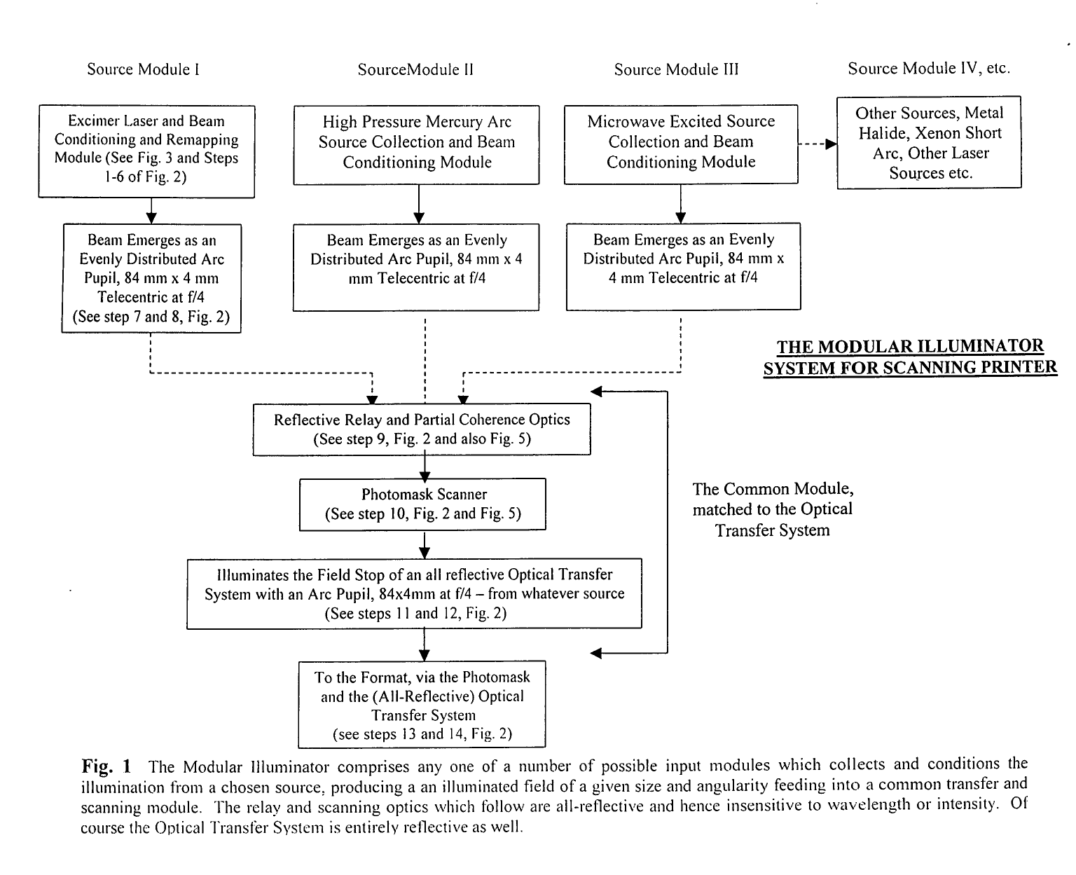

An excimer laser is chosen as an illumination source in the Source Module of the design example. The beam at the aperture of the laser FIG. 1, has a nearly gaussian distribution in one direction (Y) (3.42 mm. to the 1/e² points), and is rounded on top but approaching top-hat in the other direction (X), about 11 mm. full diameter. The light energy that leaves the laser has the somewhat rough beam quality, and the size and divergence typical of an excimer.

Within the Source Module the beam must be:
1) Cleaned up, having its irregularities removed in both directions,
2) Remapped into a nearly top-hat energy distribution in both directions, with spatial coherence reduced to a small value to avoid speckle.
3) Transformed into an arc shape of even flux distribution fitting the size and orientation of the field stop of the Optical Transfer System,
4) Diverged at f/4×f/4.

The Common Module is used with any configuration of the illuminator. In this Common Module, the beam must be:
5) Accepted at f/4 by the Reflective Relay and Partial Coherence Optics,
6) Restricted or altered as necessary to introduce desirable partial coherence properties,
7) Reimaged telecentrically at f/4 and at 1:1 magnification, through the photomask onto the field stop of the Optical Transfer System, at a second conjugate distance sufficiently long so that mirrors can be introduced in the Photomask Scanner to scan the beam across the photomask without occlusion.

In the Photomask Scanner, the beam must be:
8) Scanned across the photomask by the Photomask Scanner in synchronism with the movement of the Optical Transfer System, using an assembly of flat moving-mirror optics that preserves a constant optical appearance and constant distance as they move, as seen from either end of the system.

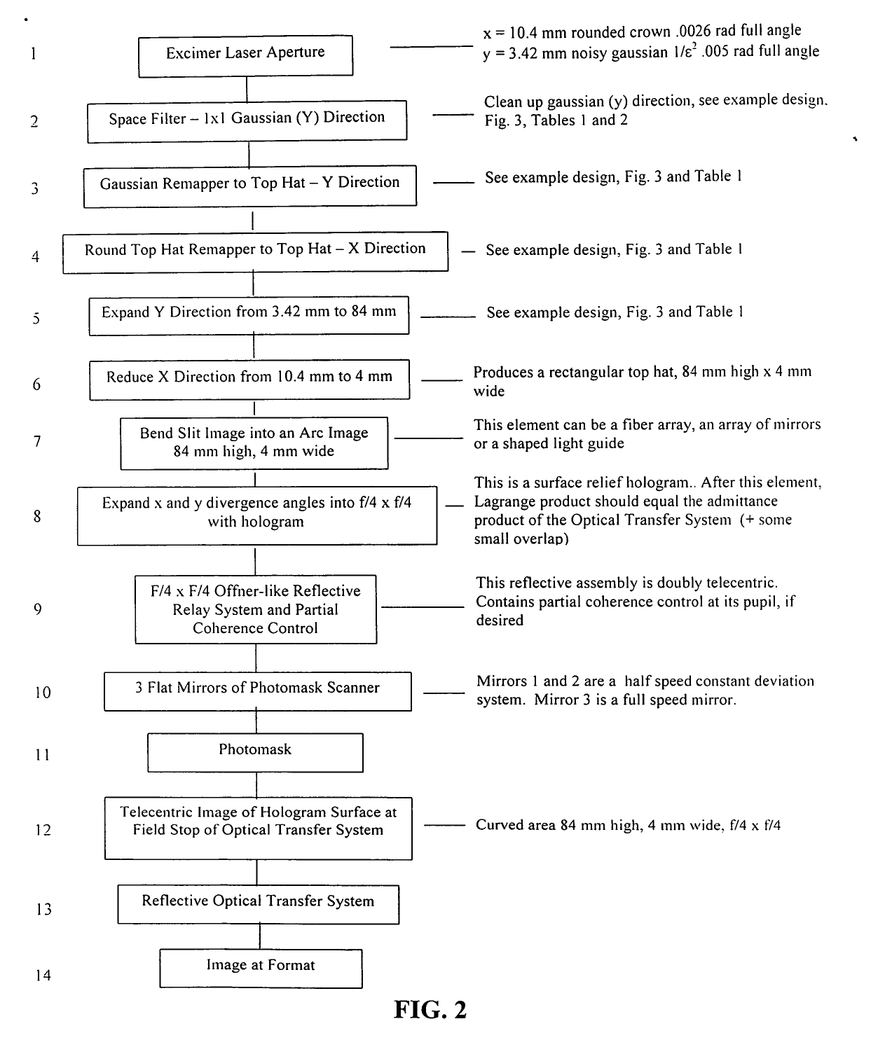

This design problem is handled by the step-by-step process described in FIG. 2. A person skilled in the art may find a number of ways in which these separate steps can be combined advantageously, to accomplish the same ends. However, the various steps are kept separate from each other in this invention disclosure, in the interests of clarity.

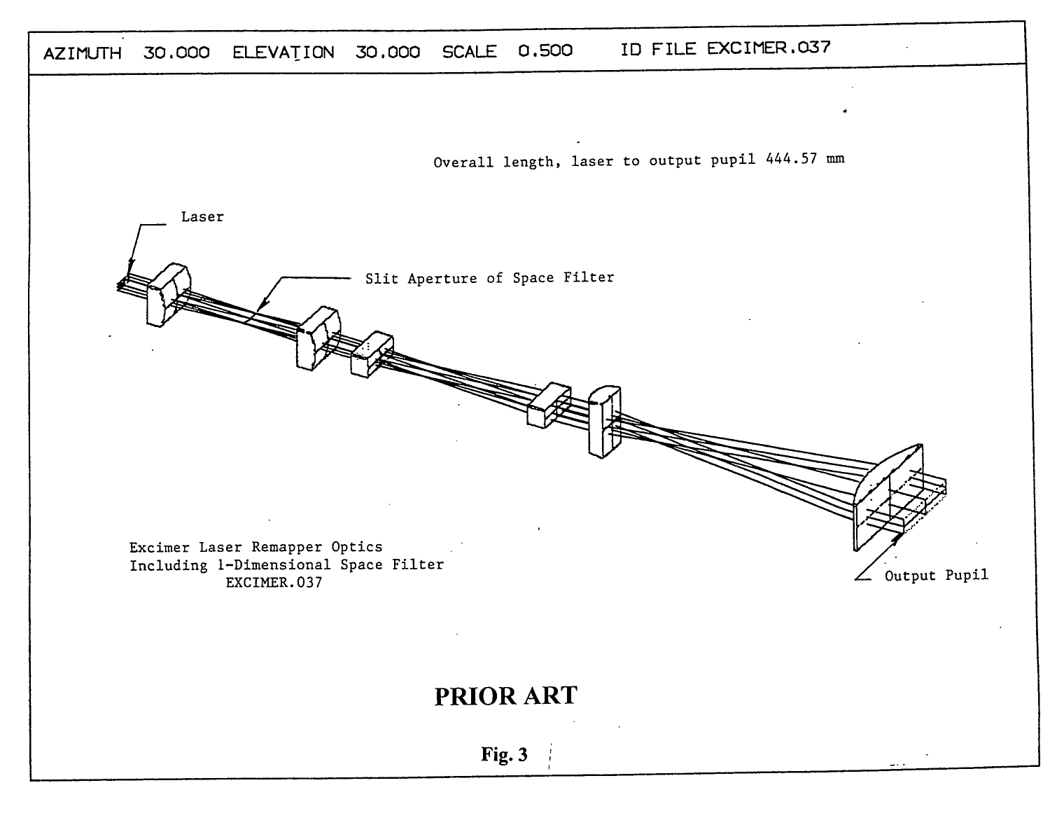

The excimer laser beam is first cleaned up and transformed into a rectangular pupil by an optical system of the type illustrated in FIG. 3 (Prior Art). The lenses shown in this example are astoric cylinders made of CaF₂ (since the wavelength used in the example and in the accompanying calculations is 193 nm.). The first group of two elements (the space filter) in the optical train in FIG. 3 comprise an afocal cylindrical telescope, with a line focus in the middle. A narrow slit aperture is placed at this point, removing the ragged amplitude noise from the Y direction gaussian distribution. The second element of this pair is a cylinder with a conic constant added, technically an astoric element. This group of two lenses puts out a beam that is smoothly gaussian in the Y direction and has a rounded top in X.

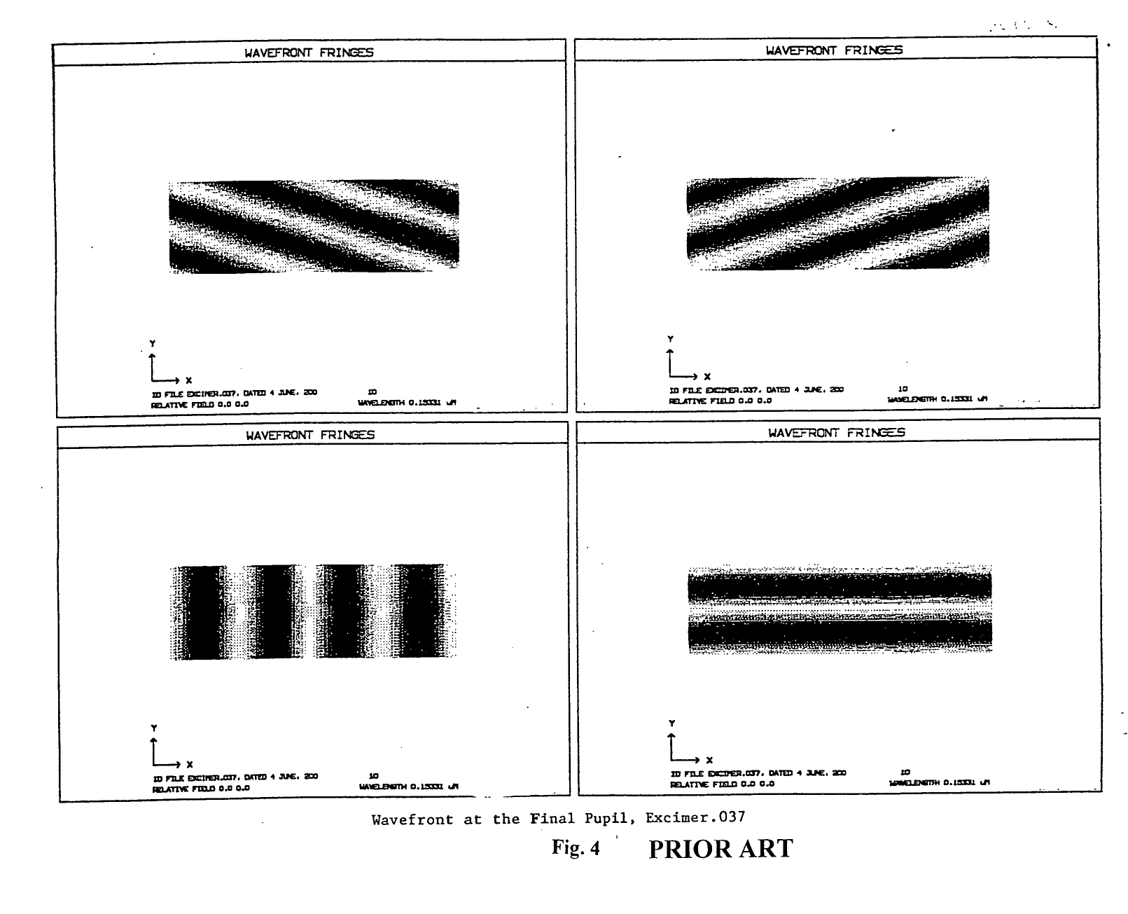

The space filter group is followed by two more double astoric telescopes, called remappers, lenses 3 and 4 in FIG. 3 comprising the first remapping telescope, and lenses 5 and 6 comprising the second remapping telescope. The first telescope redistributes the gaussian flux distribution into a top hat in the Y direction and expands the rectangular pupil to chosen dimensions. The second telescope redistributes the rounded flux distribution into a top hat in the X direction and expands the dimensions of the beam in X. The top hat distribution can be shown to be very even, by plotting the flux after the beam remapping stage. The designed quality of the emergent pupil after this series of transformations is graphically demonstrated by the fringe patterns of FIG. 4 (Prior Art). This method of redistributing energy in a beam is well known in the art (c.f. Numbered Reference 8).

The optical design of the example system up to this point is described by the Synopsys design files TABLES 1-2 (Prior Art) and the Mathcad files APPENDIX 1 (Prior Art). TABLE 1 is a design of the lens train, TABLE 2 is a table of laser waist location within the space filter.

Design of a remapping telescope requires that a set of rays be chosen, and that each ray of the set, representing a chosen energy segment of the entering beam, be assigned an individual height target in the plane of the second lens. This is done by use of the illustrated Mathcad routine, APPENDIX 1. The ray targets derived from the Mathcad computation are plugged into the Synopsys lens design, TABLE 1. The required curves of the remapper lenses are computed in Synopsys. These designs are done for application to a specific laser. However the form of the beam clean up and remapping system and the form of the mathematical procedure for computing the ray targets are completely exemplary of what might be employed in the design of any excimer Source Module embodying this invention.

The gaussian distribution of the excimer beam in the Y direction after the space filter is a known quantity. Thus this direction is chosen for expansion from 3.42 mm. to 84 mm, the long direction of the illuminated scanning aperture. The next stage that follows is a Y-direction beam expansion telescope, which accomplishes this beam expansion. This beam expansion in Y is either combined with or followed by a beam reduction telescope in the X direction, reducing the size of the X beam from 10.4 mm. to about 4 mm. This series of operations creates a rectangular pupil, about 84 mm. high and about 4 mm. wide, having in the Y direction a very small divergence typical of an expanded laser beam. When this rectangular pupil is bent, in the step that follows, it will cover the 3 mm. wide×84 mm. high arc of the Optical Transfer System field stop, with some overlap (but not yet with the correct divergence).

The figures and the calculations presented in the example above are for a design that was carried out at 193 nm. It is intended to be illustrative of the calculation and of the design process, but 193 nm. light would not pass through the fiber or holographic quartz elements that may follow. Several alternative approaches have been suggested above for mirror designs that will produce an arc pupil without transmission limitations, and similarly reflective or reflective/holographic approaches can be used to expand the beam.

Beam shuttering, beam intensity control, and beam dumping devices, while necessary, are assumed to have been included in the source module beam train. They have been ignored in the above discussion.

Another class of sources likely to be found equally as useful as the excimer laser is the class including High Pressure Mercury Arcs or the Mercury-Xenon Arcs, having a slightly different spectral distribution, referred to in FIG. 2 as Source Module 2. Here the collection and conditioning problem is somewhat different from the excimer, but the initial principles and objectives are the same. First, to collect and smooth the light in the Source Module, and then to pass the beam on to create an illuminated field at the input of the Common Module which has the shape, size, angularity and etendue required of the follow-on Optical Transfer System.

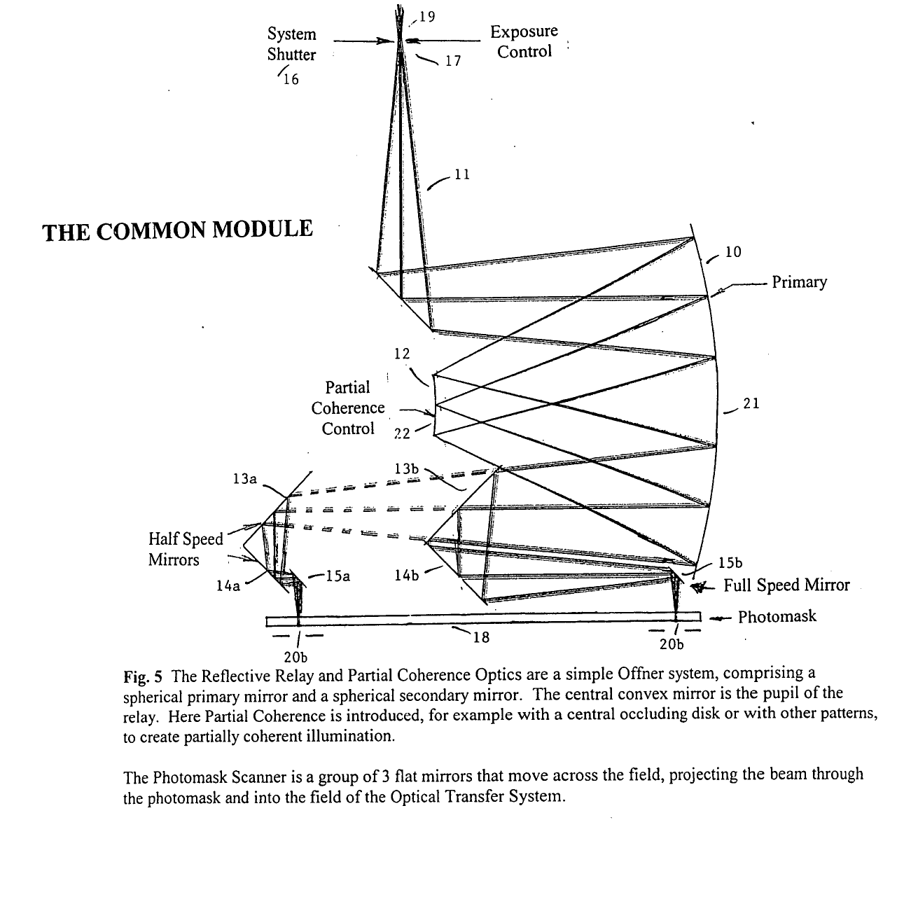

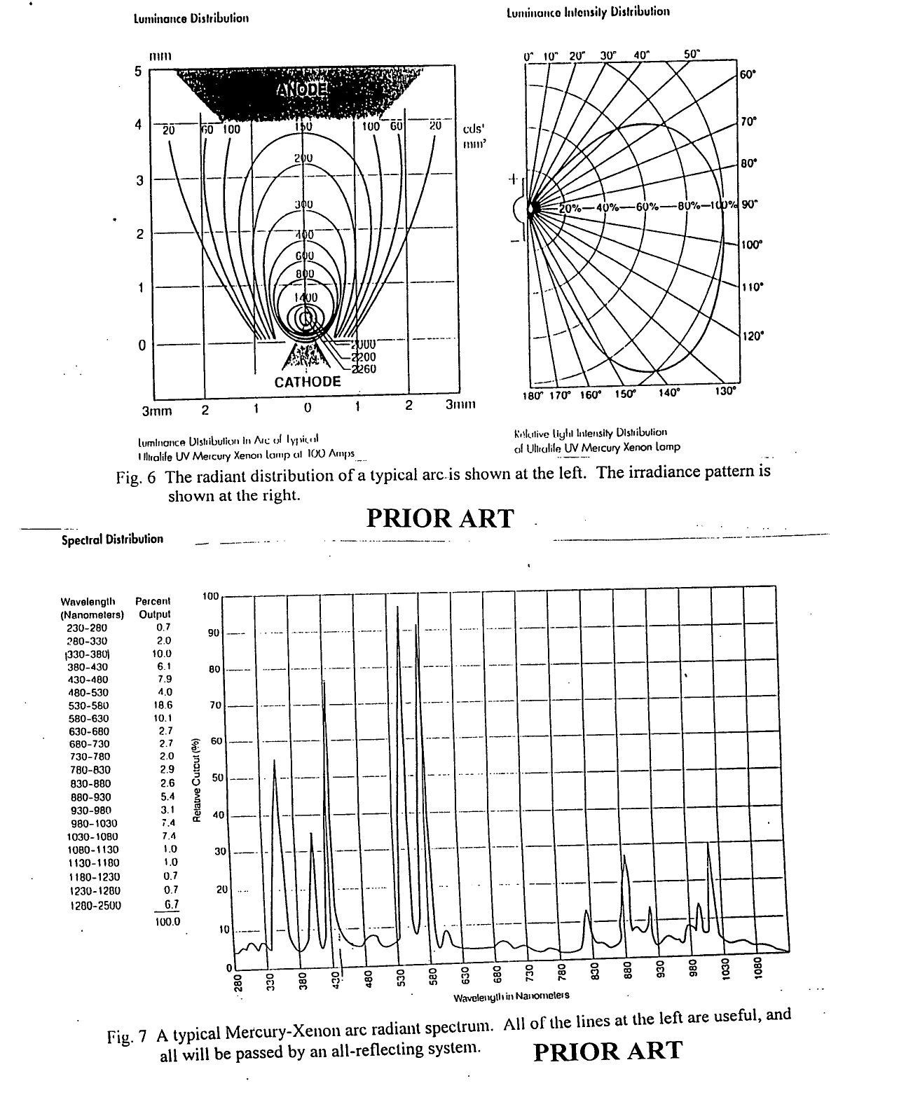

It is common practice to collect as many as seven steradians of radiant output from a High Pressure Arc, using a “deep dish” elliptical reflective collector. If seven steradians are to be collected at the source, to be fed into a follow-on system that has a (small angle) etendue of 0.165 cm²ster, it is apparent that only a small portion of the source area can be collected and used by the system. In the example design presented here this area amounts to 0.0236 cm² (2.4 mm²), or thereabouts. High pressure mercury arcs and mercury-xenon arcs have areas of the gap between the electrodes which are very hot and other areas which are not quite so hot. FIG. 6 (Prior Art) shows a luminance distribution of a typical UV mercury-xenon arc within which an area of 2.4 mm² can be selected from the hottest parts of the arc, and FIG. 7 (Prior Art) shows a typical spectral distribution of the radiation.

This portion of the arc area is selected from the total area of the reimaged arc at the front focal point of the elliptical collector. Here a light guiding quartz rod is placed having a cross-sectional shape consistent with the shape of the image of the hottest portion of the arc. The light guide mixes up the collected portion of the beam, radially inverting it several times through internal reflection, until it reemerges from the rear face. Diffractive prisms or fly's eye lens arrays may be employed for further mixing. After this point it is remapped into a long and narrow field shape which in turn is transformed into the illuminated arc field shape of the Reflective Relay and Partial Coherence Optics (the Common Module). It then may be diverged slightly with a narrow angle Light Diffusing System to accomplish further mixing. The light guiding rod is procured from Ariel Optics of Ontario, N.Y. Light Scattering Diffusers, which are surface relief phase holograms, are made of quartz, passing the ultraviolet and having the property of increasing the angularity of the beam as required. They are made by MEMS Optical Company of Huntsville, Ala. or Digital Optics Corporation of North Carolina.

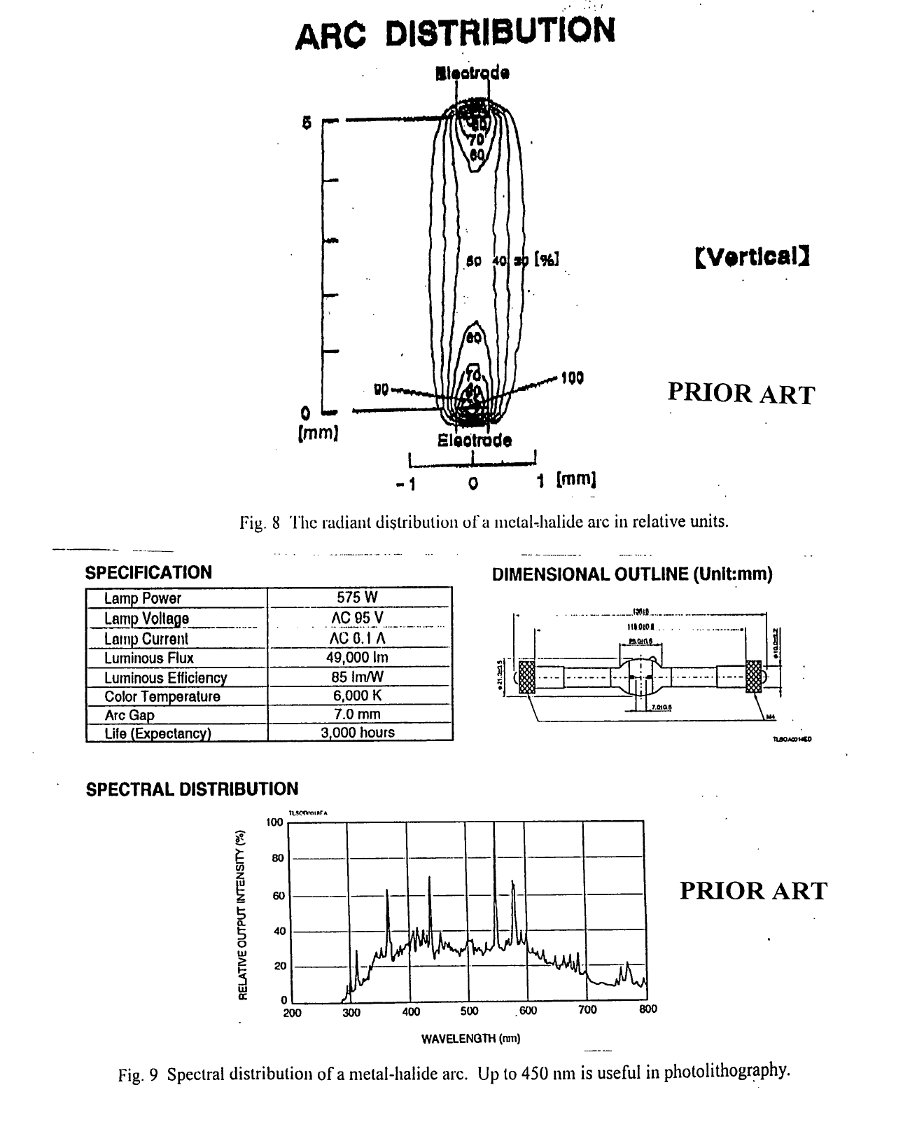

The Metal-Halide Arc, produced by Hamamatsu or by Ushio, is used in a Source Module 4 (FIG. 1) in much the same way as was the High Pressure Arc discussed above, but with dimensions and optical arrangements suitable to the size and distribution of the smaller arc. FIG. 8 (Prior Art) shows a distribution of the arc radiation in such a lamp, which is long and narrow compared with a Mercury or Mercury-Xenon lamp arc distribution (FIG. 6). The area selected to be admitted to the light guide at the far focus of the collector mirror should be correspondingly long and narrow, perhaps 0.5 mm×5.0 mm. These lamps are very bright. They also put out a very large amount of radiation in a very small area, and they last a long time. FIG. 9 (Prior Art) shows the spectral distribution of an L5431 Hamamatsu lamp that has a life time of 3000 hours. This lamp puts out 49000 lumens of radiation, about half of which is useful for photolithography.

Similar designs are possible, using other lasers, microwave excited sources, xenon arcs, pulsed or cw laser diodes or diode bars. The Fusion “D” bulb is an example of a mercury filled source which emits a very strong and very bright mercury spectrum when placed in the excitation field of a magnetron. If multiple laser diode bars are used, special combiner technology such as that exemplified in Whitney U.S. Pat. No. 6,356,380 may be employed to seamlessly join or overlay the separate laser beams. Diode laser beams are noisy and, in some cases, may have to be cleaned up in much the same way as the excimer beam illustrated earlier in this invention disclosure.

The next step (in the sequence illustrated in FIG. 2) is the conversion of the rectangular pupil into an arc. This transformation can be accomplished in one of several ways that were discussed earlier, none of which are completely efficient. The first and simplest method makes use of a coherent or random bundle of silica fibers, which accepts the rectangular pupil light on one end and after a few inches of travel is able to bend the output into the required arc at the output surface of the fiber bundle. Such a fiber bundle, built to pass ultraviolet light, can be procured from PolyMicro Technologies of Phoenix, Ariz.

Intermediate approaches are also possible, using a stack of slightly bent rectangular section light guides. Such designs are analogous to fly's eye constructions, and they work if only slight bending is needed to convert the rectangular pupil into an arc.

In a second approach the pupil can be transformed from a rectangular shape to an arc by a special two or three element optical system of lenses or mirrors. Examples of three types of off-axis three mirror optical systems that produce this end result were described earlier in this discussion. None of these systems is totally efficient in the collection of light. The best of the three for the purposes of the present design appears to be a system like Ban '538, necessarily settling for a light loss.

Immediately following the rear surface of the fiber bundle or transformation mirrors, a light scattering holographic diffuser is introduced to increase the angularity of the beam from laser dimensions (if the source is a laser) to a solid angle matched to the f/# of the following optics. A holographic diffuser suited to this purpose is a surface relief phase hologram, computed to disperse the beam from the incident illuminated field image into the acceptance f/number of the Whitney '020 Optical Transfer System, about f/4×f/4.

After the illumination beam is scattered it is expanding. It possesses the etendue and all of the other angular properties required to properly illuminate the photomask object so that it can be imaged by the Optical Transfer System, but it is expanding rather than converging. The expanding illuminated cone must be reimaged and relayed, via a one-to-one conjugate imaging stage, to converge upon and superimpose upon the field stop of the Optical Transfer System. This stage, the first part of the Common Module, FIG. 5, is called the Reflective Relay and Partial Coherence Optics, 10.

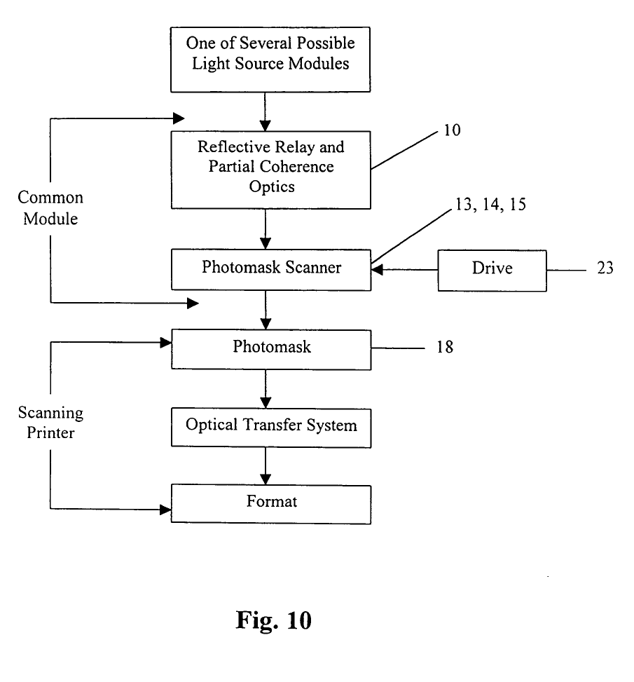

The free path length after the Reflective Relay and Partial Coherence Optics, 10, through the three mirrors comprising the Photomask Scanner system, 13, 14, 15, must be about 19.7 inches (500 mm.) to suit the optical requirements of the Optical Transfer System in the exemplary system design presented in Whitney '020. Considering the 1:1 magnification requirement and the arc shaped field which is to be transferred from object plane 19 to image plane 20, the ideal optical system for the Reflective Relay and Partial Coherence Optics 10 is a simple Offner system, a combination of one spherical primary 21 and one spherical secondary mirror 12. This group 10 should operate at f/4, have a decenter matching that of the Optical Transfer System, and have a free conjugate distance of slightly more than 500 mm. The Reflective Relay and Partial Coherence Optics system 10 is illustrated, integrated with the scanning mirror optics of the Photomask Scanner, 13, 14, 15 in FIG. 5. The Modular Illuminator system elements are shown in relation to each other, and to the Scanning Printer which follows in FIG. 10. FIG. 10 also shows the photomask scanner drive motor, 23.

Two important system functions are located in the first portion of the Common Module. These are: 1) The short-term system shutter, 16, which acts to turn off the light beam for short periods during scan turn around, etc. which is located at the entrance 19 to the Reflective Relay and Partial Coherence Optics, and 2) A mechanism for fine adjustment of field exposure, 17, which is also located close to the entrance to this module. This mechanism selectively restricts any chosen small sections of the sides of the entering arc field, enabling one to balance any unevenness of exposure that may be seen in the exposed format swath. These elements are followed by the Partial Coherence mechanism, 22, located at the limiting pupil of the entire optical illuminator. The simplest form that this mechanism can take is either an occluding ring restricting the outside portions of the central mirror 12 of the Reflective Relay assembly, or a small partially occluding central disk that is located within the central mirror.

Spatial coherence of a beam of light refers to the degree to which the phase of a wavefront removed from a point can be predicted, simply by having knowledge of the phase of the wavefront at the point. In completely coherent light, phase is predictable across distances like 50 mm., and in completely incoherent light phase knowledge is lost within 5-10 microns. In between these two states, the beam is referred to as Partially (spatially) Coherent.

When a beam of illumination light hits and passes through an object at the photomask, at least several orders of transmitted diffracted light are generated. The angles at which this diffraction takes place are governed by the grating equation:
N₁×sin ⊖₁+N₂×sin ⊖₂=M×λ/d
Where:
N₁=The index of the medium before the grating (the photomask material)
⊖₁=The angle of incidence of the light beam before it hits the grating
N₂=The index of the medium after the grating (usually air)
⊖₂=The angle of incidence of the light after it leaves the grating
M=The order of diffraction (an integer, 0, +/−1, +/−2, +−3 etc.)
λ=The wavelength of the light in a vacuum
d=The size of the grating detail (the pattern at the photomask)

The zero order is a proportion of the imaging light that goes straight through the grating, undiffracted. When M=0, the grating equation becomes Snell's law of refraction at an N₁/N₂ interface. The plus and minus first orders and the higher orders emerge from the grating (the mask pattern) at angles dictated by the grating equation, determined by the angle of incidence of the illuminating light, the size of the detail in the object and the wavelength of the illuminating light. Sharper detail information is carried in the higher orders, up to the point where the f/number of the imaging optics is no longer large enough to accept the larger diffracted angles at which these higher orders emerge. The zero order largely contributes background, zero space frequency information.

A pupil is formed at the convex mirror in the center of the Reflective Relay and Partial Coherence Optics, 12, as shown in FIG. 5. Illuminating light having all angles of incidence converges on this mirror, the smallest angles of incidence in the center of the light cones. Blocking the edges reduces the numerical aperture of the system and in accordance with the first definition of partial coherence in an illuminator, this introduces a degree of partial coherence. Referring back to the grating equation, if we instead block the central rays at this pupil, the overall distribution of angles of illumination in the pupil plane slightly favors the higher angles. This, in turn, changes the distribution of imaging rays arriving at and leaving the photomask, decreasing the proportion of zero order and the plus and minus first orders, in favor of the second and higher orders. Either operation improves the proportion of higher space frequency content of the beam and in turn, improves the rendition of detail.

Many types of blocking filters have been proposed for insertion in the beam at this point, for reinforcement of various types of patterns. Examples are given in Gallatin et al, '513, Tsacoyeanes et al '615, and Michaloski et al '000 referred to earlier.

The Reflective Relay and Partial Coherence Optics 10 illuminate the photomask object field 20 through the Photomask Scanner 13, 14, 15 (FIG. 5). This mechanism in turn directs the beam into the field stop of the Optical Transfer System of the printer. The Photomask Scanner moves the illuminated field 20 back and forth across the photomask in synchronism with the reciprocal movement of the Optical Transfer System.

The Photomask Scanner system, shown in the lower part of FIG. 5, comprises 3 flat mirrors, 13, 14, 15 two of which, 13 14, move across the photomask at half the scanning speed of the Optical Transfer System of the underlying scanning printer, from positions 13a, 14a, to positions 13b, 14b, and a final mirror, 15 that moves at full scanning speed from positions 15a to 15b. These motions are produced by Drive System 23. The optical distance through the system remains constant, across the scan. The two half speed mirrors 13, 14, which move as a unit, combine into one corner mirror assembly that comprises a constant deviation system. As a consequence the two mirror pair 13, 14, is pretty nearly immune to rocking motions in the plane of the scan. The motion and position of the full speed mirror 15 is required to track the motion and position of the Optical Transfer System field stop as it moves across the photomask. It is never required to change its angle. The illuminated field has some small overlap with the acceptance field of the Optical Transfer System, so small tracking errors in this mechanism present very little problem.

### ATTACHMENTS

TABLE 1 (3 pages) Synopsys Design of the Excimer.037 Optical Train
TABLE 2 Location of the Laser Waist in the Excimer.037 Optical Train
APPENDIX 1 (7 pages) Polynomial and Numerical Description of the Excimer Astoroidal Remapping System-Mathcad File Excimer Astoroid.001

APPENDIX 2 Numbered References

```
TABLE 1
LEO
  RLE
  ID FILE EXCIMER.037, 10
  ID1 REMAPPER INCLUDING SPACE FILTER
```

ID2 LAMBDA/30
ID3 Y DIV. .0025 RAD., X DIV. .0013 RAD.
ID4 1/E\hat{ }2 Y 3.42/2 MM. X 11.02/2 MM.
ID5 X PUPIL TO 5.442885, Y WAIST TO .014 AT SUR 4

```
  WAVL .193311 .193311 .193311
  APS 1
  AFOCAL
  GLOBAL
  XPXT
  RPUPIL
  UNITS MM
```

| | | |
|---|---|---|
| OBJ INFINITE | 0.07163000 | 0.03725000 |

| | | | | |
|---|---|---|---|---|
| REF HEIGHT | 1.70940000 | 0.04137841 | 5.44288500 | −0.08184504 |

| | | | | |
|---|---|---|---|---|
| 0 | AIR | | | |
| 1 | CV | 0.00000000 | TH | 20.00000000 |
| 1 | AIR | | | |

| | | | | | |
|---|---|---|---|---|---|
| 2 | RAO | 25.00000000 | 20.00000000 | 0.00000000 | 0.00000000 |

| | | | | |
|---|---|---|---|---|
| 2 | CV | 0.00000000 | TH | 10.00000000 |

| 2 | N1 1.501485 N2 1.501485 N3 1.501485 | | | | |
|---|---|---|---|---|---|
| 2 | GID ‘GLASS’ | | | | |
| 3 | RAO | 25.00000000 | 20.00000000 | 0.00000000 | 0.00000000 |

| | | | | |
|---|---|---|---|---|
| 3 | CV | −0.05000000 | TH | 39.88150000 |
| 3 | AIR | | | |

| | | |
|---|---|---|
| 3 | TORIC | 0.00000000 |

| | | | | | |
|---|---|---|---|---|---|
| 4 | RAO | 11.00000000 | 0.10000000 | 0.00000000 | 0.00000000 |

| | | | | |
|---|---|---|---|---|
| 4 | CV | 0.00000000 | TH | 32.68760477 |
| 4 | AIR | | | |

| | | | | | |
|---|---|---|---|---|---|
| 5 | RAO | 25.00000000 | 20.00000000 | 0.00000000 | 0.00000000 |

| | | | | |
|---|---|---|---|---|
| 5 | CV | 0.00000000 | TH | 10.00000000 |

| 5 | N1 1.501485 N2 1.501485 N3 1.501485 | | | | |
|---|---|---|---|---|---|
| 5 | GID ‘GLASS’ | | | | |
| 6 | RAO | 25.00000000 | 20.00000000 | 0.00000000 | 0.00000000 |

| | | | | |
|---|---|---|---|---|
| 6 | RAD | −19.73266812 | TH | 20.00000000 |
| 6 | AIR | | | |
| 6 | CC | −2.80414641 | | |

| | | |
|---|---|---|
| 6 | ASTOR | 0.00000000 |

| | | | | | |
|---|---|---|---|---|---|
| 6 | AT1 | 0.000000000E+00 | 0.000000000E+00 | 0.000000000E+00 | 0.000000000E+00 |
| 6 | AT2 | 0.000000000E+00 | 0.000000000E+00 | 0.000000000E+00 | 0.000000000E+00 |
| 6 | AT3 | 0.000000000E+00 | 0.000000000E+00 | 0.000000000E+00 | 0.000000000E+00 |
| 6 | AT4 | 0.000000000E+00 | 0.000000000E+00 | 0.000000000E+00 | 0.000000000E+00 0 |

| | | | | |
|---|---|---|---|---|
| 7 | CV | 0.00000000 | TH | 0.00000000 |
| 7 | AIR | | | |

| | | | | | |
|---|---|---|---|---|---|
| 8 | RAO | 25.00000000 | 10.00000000 | 0.00000000 | 0.00000000 |

| | | | | |
|---|---|---|---|---|
| 8 | CV | 0.00000000 | TH | 10.00000000 |

| 8 | N1 1.501485 N2 1.501485 N3 1.501485 | | | | |
|---|---|---|---|---|---|
| 8 | GID ‘GLASS’ | | | | |
| 9 | RAO | 25.00000000 | 10.00000000 | 0.00000000 | 0.00000000 |

| | | | | |
|---|---|---|---|---|
| 9 | RAD | −4.89366266 | TH | 90.00000000 |
| 9 | AIR | | | |

| | | |
|---|---|---|
| 9 | CC | −4.63174945 |

| | | |
|---|---|---|
| 9 | ASTOR | 0.00000000 |

| | | | | | |
|---|---|---|---|---|---|
| 9 | AT1 | 5.167133455E−02 | 0.000000000E+00 | −3.439067218E−04 | 0.000000000E+00 |
| 9 | AT2 | 0.000000000E+00 | −6.764478261E−05 | 0.000000000E+00 | 0.000000000E+00 |
| 9 | AT3 | 0.000000000E+00 | 5.351462276E−06 | 0.000000000E+00 | 0.000000000E+00 |
| 9 | AT4 | 0.000000000E+00 | 0.000000000E+00 | 0.000000000E+00 | −1.288521772E−07 0 |

| | | | | | |
|---|---|---|---|---|---|
| 10 | RAO | 25.00000000 | 10.00000000 | 0.00000000 | 0.00000000 |

| | | | | |
|---|---|---|---|---|
| 10 | RAD | 427.07587277 | TH | 10.00000000 |

| 10 | N1 1.501485 N2 1.501485 N3 1.501485 | |
|---|---|---|
| 10 | GID ‘GLASS’ | |
| 10 | CC 8935.84228536 | |
| 10 | ASTOR | 0.00000000 |

| | | | | | |
|---|---|---|---|---|---|
| 10 | AT1 | 1.301521158E−02 | 0.000000000E+00 | 4.031880625E−06 | 0.000000000E+00 |
| 10 | AT2 | 0.000000000E+00 | −1.563052904E−08 | 0.000000000E+00 | 0.000000000E+00 |
| 10 | AT3 | 0.000000000E+00 | 9.079055353E−12 | 0.000000000E+00 | 0.000000000E+00 |
| 10 | AT4 | 0.000000000E+00 | 0.000000000E+00 | 0.000000000E+00 | −3.323311355E−13 0 |

| | | | | | |
|---|---|---|---|---|---|
| 11 | RAO | 25.00000000 | 10.00000000 | 0.00000000 | 0.00000000 |

| | | | | |
|---|---|---|---|---|
| 11 | CV | 0.00000000 | TH | 20.00000000 |
| 11 | AIR | | | |

| | | |
|---|---|---|
| 12 | CC | −1.83832832 |

| | | |
|---|---|---|
| 12 | ASTOR | 0.00000000 |

| | | | | | |
|---|---|---|---|---|---|
| 12 | AT1 | 2.767725088E−04 | 0.000000000E+00 | 2.311610727E−06 | 0.000000000E+00 |
| 12 | AT2 | 0.000000000E+00 | −3.741150335E−08 | 0.000000000E+00 | 0.000000000E+00 |
| 12 | AT3 | 0.000000000E+00 | −2.451058597E−09 | 0.000000000E+00 | 0.000000000E+00 |
| 12 | AT4 | 0.000000000E+00 | 0.000000000E+00 | 0.000000000E+00 | 5.019647315E−11 0 |

| | | | | |
|---|---|---|---|---|
| 12 | DECEN | 0.00000000 | 0.00000000 | 0.00000000 99 |

| 12 | GT | −90.00000000 | 0.00000000 99 | | |
|---|---|---|---|---|---|
| 13 | RAO | 30.00000000 | 18.00000000 | 0.00000000 | 0.00000000 |

| | | | |
|---|---|---|---|
| 13 | RAD | 1.00000000E+07 | TH 142.00000000 |
| 13 | AIR | | |
| 14 | CV | 0.00000000 | TH 0.00000000 |
| 14 | AIR | | |

| | | | | | |
|---|---|---|---|---|---|
| 15 | RAO | 25.00000000 | 65.00000000 | 0.00000000 | 0.00000000 |

| | | | |
|---|---|---|---|
| 15 | RAD | 75.38713582 | TH 10.00000000 |

| 15 | N1 1.501485 N2 1.501485 N3 1.501485 | |
|---|---|---|
| 15 | GID ‘GLASS’ | |
| 15 | CC | −2.88822050 |

| | | |
|---|---|---|
| 15 | ASTOR | 0.00000000 |

| | | | | | |
|---|---|---|---|---|---|
| 15 | AT1 | 1.729606105E−03 | 0.000000000E+00 | −1.007613347E−08 | 0.000000000E+00 |
| 15 | AT2 | 0.000000000E+00 | 1.774530374E−11 | 0.000000000E+00 | 0.000000000E+00 |
| 15 | AT3 | 0.000000000E+00 | 3.177712250E−15 | 0.000000000E+00 | 0.000000000E+00 |
| 15 | AT4 | 0.000000000E+00 | 0.000000000E+00 | 0.000000000E+00 | 0.000000000E+00 0 |

| | | | | | |
|---|---|---|---|---|---|
| 16 | RAO | 25.00000000 | 65.00000000 | 0.00000000 | 0.00000000 |

| | | | |
|---|---|---|---|
| 16 | CV | 0.00000000 | TH 20.00000000 |
| 16 | AIR | | |

| | | | | | |
|---|---|---|---|---|---|
| 17 | RAO | 8.01000000 | 0.0000000 | 0.00000000 | 0.00000000 |

| | | | | |
|---|---|---|---|---|
| 17 | CV | 0.00000000 | TH | 0.00000000 |
| 17 | AIR | | | |

| | | | | | |
|---|---|---|---|---|---|
| 18 | RAO | 8.01000000 | 42.01000000 | 0.00000000 | 0.00000000 |

| | | | | |
|---|---|---|---|---|
| 18 | CV | 0.00000000 | TH | 0.00000000 |
| 18 | AIR | | | |

| | | | | | |
|---|---|---|---|---|---|
| 19 | RAO | 8.01000000 | 42.01000000 | 0.00000000 | 0.00000000 |

| | | | | |
|---|---|---|---|---|
| 19 | CV | 0.00000000 | TH | 0.00000000 |
| 19 | AIR | | | |

| | | | | | |
|---|---|---|---|---|---|
| 20 | RAO | 8.01000000 | 42.01000000 | 0.00000000 | 0.00000000 |

| | | | | |
|---|---|---|---|---|
| 20 | CV | 0.00000000 | TH | 0.00000000 |
| 20 | AIR | | | |

END
SYNOPSYS AI>

TABLE 2
GAUSSIAN BEAM ANALYSIS

| SURF | BEAM RADIUS | WAIST LOCATION | WAIST RADIUS | DIVERGENCE | |
|---|---|---|---|---|---|
| 1 | 1.7094 | 1.0214E−14 | 1.7094 | 3.5997E−05 | Waist |
| 2 | 1.7094 | −30.0297 | 1.7094 | 2.3974E−05 | Location |
| 3 | 1.7094 | 39.8815 | 0.0014 | 0.0429 | 39.8815 mm |
| 4 | 0.0014 | 4.2466E−05 | 0.0014 | 0.0429 | beyond |
| 5 | 1.4011 | −49.0799 | 0.0014 | 0.0285 | Surface 3 |
| 6 | 1.6865 | −1113.4455 | 1.6860 | 3.6496E−05 | |
| 7 | 1.6865 | −1133.4455 | 1.6860 | 3.6496E−05 | |
| 8 | 1.6865 | −1133.4455 | 1.6860 | 3.6496E−05 | |
| 9 | 1.6865 | −1133.4455 | 1.6860 | 3.6496E−05 | |
| SYNOPSYS AI> | | | | | |

### APPENDIX 1

Polynomial and Numerical Description of the Excimer Astoroidal Remapping System, Synopsys File Excimer.027, Mathcad File Excimer Astoroid.001,

This file computes sag of the four cylindrical astoroids, which make up the excimer remapping system, Excimer.027. The values will be checked against sags which are printed out of the Synopsys program. Surfaces 7 and 10 are rotated 90 degrees from surfaces 3 and 4.

These sag tables are in mm. and they are not broken down into enough detail to be used for any purpose other than to check the equation used to generate the lenses.
Astoric surface parameters for surface 3:

$${R}_{y} := - 4.10273909 \qquad {c}_{y} := \frac{1}{{R}_{y}} \qquad {R}_{x} := 1 \cdot {10}^{11} \qquad {c}_{x} := \frac{1}{{R}_{x}}$$

$$CC := - 3.78830081$$

$$g 1 := 6.587784619 \cdot {10}^{- 2} \qquad g 3 := - 4.625092503 \cdot {10}^{- 4}$$

$$g 6 := - 6.764478261 \cdot {10}^{- 5}$$

$$g 10 := 5.351462276 \cdot {10}^{- 6} \qquad g 16 := - 1.288521772 \cdot {10}^{- 7}$$

The sag in the YZ plane is given by:

$$z ( y ) := \frac{{c}_{y} \cdot {y}^{2}}{1 + \sqrt{1 - ( 1 + CC ) \cdot {c}_{y}^{2} \cdot {y}^{2}}} + ( g 1 \cdot {y}^{2} + g 3 \cdot {y}^{4} + g 6 \cdot {y}^{6} + g 10 \cdot {y}^{8} + g 16 \cdot {y}^{10} )$$

To produce an astoric surface: rotate the Y-Z curve along an axis parallel to the Y-axis. The sag point (x,y,z) thus lies on a circle with an axis parallel to Y displaced over the distance Rx. The radius of this circle is determined by the distance from this axis to the sag (z(y)) curve in the YZ plane:
x²+(z(y)−Rₓ)²−(Rₓ−z(y))²=0
This equation involves the above equation as a variable.

Solving this equation for z we get the tri-dimensional sag equation without prism:
ZT(x,y):=Rₓ+−{square root over ((Rₓ²−x²−2·Rₓ·z(y)+z(y)²))}

Tabulating results for a matrix of z values over the actual used aperture of the lens:
n :=05 in :=05 y height is 1.72, from Synopsys
xₙ :=1.088-n x height is 5.44
yₘ :=0.344.m
Sag_{n,m} :=ZT(xₙ,yₘ) Resulting z values will be in mm.

### Appendix 1 (cont.)

$$Sag = [ \begin{matrix}0 & - 6.561 \cdot {10}^{- 3} & - 0.026 & - 0.055 & - 0.092 & - 0.135 \\ 0 & - 6.561 \cdot {10}^{- 3} & - 0.026 & - 0.055 & - 0.092 & - 0.135 \\ 0 & - 6.561 \cdot {10}^{- 3} & - 0.026 & - 0.055 & - 0.092 & - 0.135 \\ 0 & - 6.561 \cdot {10}^{- 3} & - 0.026 & - 0.055 & - 0.092 & - 0.135 \\ 0 & - 6.561 \cdot {10}^{- 3} & - 0.026 & - 0.055 & - 0.092 & - 0.135 \\ 0 & - 6.561 \cdot {10}^{- 3} & - 0.026 & - 0.055 & - 0.092 & - 0.135\end{matrix} ]$$

Horizontal is the Y (aspheric) axis, the 1.72 mm, direction. It is 5.44 mm. from top to the left bottom corner (center of the lens).

The above table agrees with Synopsys in the y direction, and it has no power in the orthogonal direction.

Repeating for surface four:

Astoric surface parameters for surface 4:

$${R}_{y} := 81.53051892 \qquad {c}_{y} := \frac{1}{{R}_{y}} \qquad {R}_{x} := 1 \cdot {10}^{11} \qquad {c}_{x} := \frac{1}{{R}_{x}}$$

$$CC := 26.91900166$$

$$g 1 := - 6.612562752 \cdot {10}^{- 4} \qquad g 3 := - 6.153076477 \cdot {10}^{- 6}$$

$$g 6 := - 1.563052904 \cdot {10}^{- 8}$$

$$g 10 := 9.079055353 \cdot {10}^{- 12} \qquad g 16 := - 3.323311355 \cdot {10}^{- 13}$$

The sag In the YZ plane is given by:

$$z ( y ) := \frac{{c}_{y} \cdot {y}^{2}}{1 + \sqrt{1 - ( 1 + CC ) \cdot {c}_{y}^{2} \cdot {y}^{2}}} + ( g 1 \cdot {y}^{2} + g 3 \cdot {y}^{4} + g 6 \cdot {y}^{6} + g 10 \cdot {y}^{8} + g 16 \cdot {y}^{10} )$$

$${x}^{2} + {( z ( y ) - {R}_{x} )}^{2} - {( {R}_{x} - z ( y ) )}^{2} = 0$$

This equation involves the above equation as a variable.

Solving this equation for z we get the tri-dimensional sag equation without prism:
ZT(x,y):=Rₓ+−{square root over ((Rₓ²−x²−2·Rₓ·z(y)+z(y)²))}

Tabulating results for a matrix of z values over the actual used aperture of the lens: n:=0.5 m :=0.5 y height is 11.767, from Synopsys. Max. sag is 0.76666. xₙ :=1.0886.n x height is 5.443 yₘ:=2.3534.m Sag_{n,m}:=ZT(xₙ,yₘ) Resulting z values will be in mm.

### Appendix 1 (cont.)

$$Sag = [ \begin{matrix}0 & 0.03 & 0.121 & 0.273 & 0.487 & 0.767 \\ 0 & 0.03 & 0.121 & 0.273 & 0.487 & 0.767 \\ 0 & 0.03 & 0.121 & 0.273 & 0.487 & 0.767 \\ 0 & 0.03 & 0.121 & 0.273 & 0.487 & 0.767 \\ 0 & 0.03 & 0.121 & 0.273 & 0.487 & 0.767 \\ 0 & 0.03 & 0.121 & 0.273 & 0.487 & 0.767\end{matrix} ]$$

Horizontal is the Y (aspheric) axis, the 1.72 mm. direction. It is 5.44 mm. from top to the left bottom corner (center of the lens).

The above table agrees with Synopsys in the y direction, and it has no power in the orthogonal direction.

Surface seven is rotated 90 degrees, but it is computed in y coordinates.

Repeating for surface seven:

Astoric surface parameters for surface 7:

$${R}_{y} := 16.40828900 \qquad {c}_{y} := \frac{1}{{R}_{y}} \qquad {R}_{x} := 1 \cdot {10}^{11} \qquad {c}_{x} := \frac{1}{{R}_{x}}$$

$$CC := - .88060033$$

$$g 1 := - 7.19797394 \cdot {10}^{- 5} \qquad g 3 := - 9.996334885 \cdot {10}^{- 7}$$

$$g 6 := - 1.553535529 \cdot {10}^{7}$$

$$g 10 := 1.191007354 \cdot {10}^{- 8} \qquad g 16 := - 1.999226709 \cdot {10}^{- 10}$$

The sag in the YZ plane is given by:

$$z ( y ) := \frac{{c}_{y} \cdot {y}^{2}}{1 + \sqrt{1 - ( 1 + CC ) \cdot {c}_{y}^{2} \cdot {y}^{2}}} + ( g 1 \cdot {y}^{2} + g 3 \cdot {y}^{4} + g 6 \cdot {y}^{6} + g 10 \cdot {y}^{8} + g 16 \cdot {y}^{10} )$$

$${x}^{2} + {( z ( y ) - {R}_{x} )}^{2} - {( {R}_{x} - z ( y ) )}^{2} = 0$$

This equation involves the above equation as a variable.

Solving this equation for z we get the tri-dimensional sag equation without prism:
ZT(x,y):=Rₓ+−{square root over ((Rₓ²−x²−2·Rₓ·z(y)+z(y)²))}

Tabulating results for a matrix of z values over the actual used aperture of the lens: n :=0.5 m :=0.5 y height is 11.755, from Synopsys. Max. sag xₙ :=1.0886.n is −1.894. This is a reversal, but it does not appear in the manufactured lens. yₘ :=^{2.35113}.m x height is 5.443 Sag_{n,m} :=ZT(xₙ,yₘ) Resulting z values will be in mm.

### Appendix 1 (cont.)

$$Sag = [ \begin{matrix}\begin{matrix}0 & 0.168 & 0.673 & 1.511 & 2.247 & - 1.894\end{matrix} \\ \begin{matrix}0 & 0.168 & 0.673 & 1.511 & 2.247 & - 1.894\end{matrix} \\ \begin{matrix}0 & 0.168 & 0.673 & 1.511 & 2.247 & - 1.894\end{matrix} \\ \begin{matrix}0 & 0.168 & 0.673 & 1.511 & 2.247 & - 1.894\end{matrix} \\ \begin{matrix}0 & 0.168 & 0.673 & 1.511 & 2.247 & - 1.894\end{matrix} \\ \begin{matrix}0 & 0.168 & 0.673 & 1.511 & 2.247 & - 1.894\end{matrix}\end{matrix} ]$$

Horizontal is the Y (aspheric) axis, the 1.72 mm. direction. It is 5.44 mm. from top to the left bottom corner.

The above table agrees with Synopsys in the y direction, and it has no power in the orthogonal direction

This lens has a bad cusp at the edge, before it is apertured to accommodate the real pupil. After it is cut, the cusp doesn't appear.

Repeating for surface 10, also rotated 90 degrees from surfaces 3 and 4.

Astoric surface parameters for surface 10:

$${R}_{y} := 353.39956522 \qquad {c}_{y} := \frac{1}{{R}_{y}} \qquad {R}_{x} := 1 \cdot {10}^{11} \qquad {c}_{x} := \frac{1}{{R}_{x}}$$

$$CC := 9.11045214$$

$$g 1 := 2.225611907 \qquad g 3 := - 8.624272402 . \cdot {10}^{- 8}$$

$$g 6 := - 7.871681463 \cdot {10}^{- 7}$$

$$g 10 := 0 \qquad g 16 := 0$$

The sag in the YZ plane is given by:

$$z ( y ) := \frac{{c}_{y} \cdot {y}^{2}}{1 + \sqrt{1 - ( 1 + CC ) \cdot {c}_{y}^{2} \cdot {y}^{2}}} + ( g 1 \cdot {y}^{2} + g 3 \cdot {y}^{4} + g 6 \cdot {y}^{6} + g 10 \cdot {y}^{8} + g 16 \cdot {y}^{10} ) {x}^{2} + {( z ( y ) - {R}_{x} )}^{2} - {( {R}_{x} - z ( y ) )}^{2} = 0$$

This equation involves the above equation as a variable.

Solving this equation for z we get the tri-dimensional sag equation without prism:
ZT(x,y):=Rₓ+−{square root over ((Rₓ²−x²−2·Rₓ·z(y)+z(y)²))}

Tabulating results for a matrix of z values over the actual used aperture of the lens: n :=05m:=05 y height is 48.0, from Synopsys. Max. sag is 8.098. xₙ:=1.0886-n x height is 5.443 yₘ:=9.6.m Sag_{n,m} :=ZT(xₙ,yₘ) Resulting z values will be in mm.

### Appendix 1 (cont.)

$$Sag = [ \begin{matrix}0 & 0.335 & 1.334 & 2.981 & 5.247 & 8.098 \\ 0 & 0.335 & 1.334 & 2.981 & 5.247 & 8.098 \\ 0 & 0.335 & 1.334 & 2.981 & 5.247 & 8.098 \\ 0 & 0.335 & 1.334 & 2.981 & 5.247 & 8.098 \\ 0 & 0.335 & 1.334 & 2.981 & 5.247 & 8.098 \\ 0 & 0.335 & 1.334 & 2.981 & 5.247 & 8.098\end{matrix} ]$$

Horizontal is the Y (aspheric) axis, the 48.0 mm. direction. It is 5.44 mm. from top to the left bottom corner, (center of the lens).

The above table agrees with Synopsys in the y direction, and it has no power in the orthogonal direction SAG 3 ID EXCIMER REMAPPER 6 14 16:07:02 SAG TABLE SURF SEMI-APERTURE AXIAL RADIUS SURFACE TYPE Appendix 1 3 3.50000-4.10274 ASPHERIC TOROID (cont.)

| Y-HEIGHT | SAG |
|---|---|
| 0.35000 | −0.00679 |
| 0.70000 | −0.02639 |
| 1.05000 | −0.05675 |
| 1.40000 | −0.09519 |
| 1.75000 | −0.13917 |
| 2.10000 | −0.18668 |
| 2.45000 | −0.23644 |
| 2.80000 | −0.28760 |
| 3.15000 | −0.33947 |
| 3.50000 | −0.39131 |

SYNOPSYS AI>SAG 4

ID EXCIMER REMAPPER 6 14 16:07:09

SAG TABLE

SURF SEMI-APERTURE AXIAL RADIUS SURFACE TYPE 4 12.50000 81.53052 ASPHERIC TOROID

| Y-HEIGHT | SAG |
|---|---|
| 1.25000 | 0.00855 |
| 2.50000 | 0.03421 |
| 3.75000 | 0.07699 |
| 5.00000 | 0.13695 |
| 6.25000 | 0.21412 |
| 7.50000 | 0.30863 |
| 8.75000 | 0.42066 |
| 10.00000 | 0.55057 |
| 11.25000 | 0.69918 |
| 12.50000 | 0.86943 |

SYNOPSYS AI>SAG 7

ID EXCIMER REMAPPER 6 14 16:07:23

SAG TABLE

SURF SEMI-APERTURE AXIAL RADIUS SURFACE TYPE 7 8.00000 16.40829 ASPHERIC TOROID

| Y-HEIGHT | SAG |
|---|---|
| 0.80000 | 0.01946 |
| 1.60000 | 0.07784 |
| 2.40000 | 0.17517 |
| 3.20000 | 0.31149 |
| 4.00000 | 0.48695 |
| 4.80000 | 0.70186 |
| 5.60000 | 0.95638 |
| 6.40000 | 1.24904 |
| 7.20000 | 1.57198 |
| 8.00000 | 1.89999 |

SYNOPSYS AI>SAG 10

ID EXCIMER REMAPPER 6 14 16:07:30

SAG TABLE

SURF SEMI-APERTURE AXIAL RADIUS SURFACE TYPE 10 50.00000 353.39957 ASPHERIC TOROID

| Y-HEIGHT | SAG |
|---|---|
| 5.00000 | 0.09098 |
| 10.00000 | 0.36347 |
| 35.00000 | 4.37536 |
| 40.00000 | 5.68240 |
| 45.00000 | 7.14640 |
| 50.00000 | 8.76183 |

SYNOPSYS AI>

### APPENDIX 2

### Numbered References

1. “Annular Field Systems and the Future of Optical Microlithography” Abe Offner, Optical Engineering, Pp. 294-299, April 1987
2. “Evolution of Ring Field Systems in Microlithography” D. M. Williamson, SPIE Vol. 3482, Pp. 369-376
3. “New Developments in the Design of Ring-field Projection Cameras for EUV Lithography: Passive Pupil Correction” J. M. Sasian, SPIE Vol. 3482, Pp. 658-663
4. “Annular Surfaces in Annular Field Systems” J. M. Sasian, Optical Engineering, Vol. 36, Pp. 3401-3403 December, 1997.
5. “Complete Analysis of a Two-Mirror Unit Magnification System. Part 1” A. Suzuki, Applied Optics, Vol. 22, No. 24, Pp. 3943-3949, December 1983
6. “Complete Analysis of a Two-Mirror Unit Magnification System. Part 2” A. Suzuki, Applied Optics, Vol. 22, No. 24, Pp. 3950-3956, December 1983
7. “Applications of Coherence Theory in Microscopy and Interferometry” H. H. Hopkins, Journal of the Optical Society, Vol. 47, No. 6, Pp. 508-526, June 1957
8. “Design and Optimization of an Irradiance Profile-Shaping System with a Generic Algorithm Method,” N. Evans and D. Shealy, Applied Optics. Vol. 37, pp. 5216-5221 (1998).
9. “A Large Flat Panel Printer”, T. R. Whitney, paper presented to the Society for Imaging Science and Technology 49^{th} Annual Conference May 19-24, 1996

1. A modular system providing scanning beam illumination of predetermined characteristics to a traversing optical transfer system in response to input illumination from any of a number of sources which may vary in wavelength, intensity, repetition rate and geometrical configuration, the input illumination providing a beam as an illuminated arc, to be configured by the modular system to a scanning beam delivered via a photomask to an optical transfer system movable along a flat format, comprising:
an input light source system providing a diverging beam as an illuminated arc;
a reflective relay system receiving the illuminated arc and disposed along the flat format to generate a reflecting beam path including diverging and converging sections, the reflective relay system including a primary concave mirror and a convex mirror, positioned to deflect the beam from the arc successively off the concave mirror, the convex mirror and the concave mirror a second time, and
the illuminator further including a output stage movable in parallel with the optical transfer system along the flat format and comprising a series of planar mirrors disposed in the converging path of the beam from the reflective relay system, to direct a scanning beam transversely along the flat format into the optical transfer system through the photomask, wherein the scanning beam converges to a focus at the surface of the photomask.

2. A system as set forth in claim 1, wherein the convex mirror is disposed and apertured to introduce partial coherence in the beam.

3. A system as set forth in claim 2 above, wherein the reflective relay and partial coherence control comprises a major concave reflector positioned to reflect converging and diverging rays off different sectors of the reflector, wherein the convex mirror is positioned to intercept a first reflection from the concave mirror, wherein the convex mirror is apertured for coherence control in a direction substantially perpendicular to the median of the entering and leaving beams intercepted thereby, and wherein the series of flat mirrors receiving the second reflection off the concave mirror comprises a movable assembly transportable along the plane of the format.

4. A system as set forth in claim 3 above, wherein the series of flat mirrors comprise a reflecting roof mirror with an apex directed substantially parallel to the format plane, and positioned to direct the converging beam along a varying position as the movable assembly is transported and the series of flat mirrors also includes a reflector which focuses a line image at the photomask.

5. A system as set forth in claim 3 above, wherein the system further includes an input system including a shutter and exposure control and, wherein the system further includes an optical transfer system for receiving the diverging beam from the assembly of flat mirrors and moving in synchronism with the flat mirror system.

6. A system as set forth in claim 3 above, wherein the system further includes an input system including a shutter and exposure control and, wherein the system contains means for fine adjustment of the intensity of the exposed image in various parts of the scanning field.

7. A system for using different illumination sources and a specific optical transfer mechanism which traverses cyclically with respect to an elongated photomask disposed along a flat format, comprising the combination of:
a source module having an intensive light source;
an input system responsive to the light source and including an intensity control, a shutter mechanism for selectively blocking the light source, and optics for shaping the beam into an illuminated arc of selected size and aspect ratio;
a module for illumination of an optical transfer device adjacent a photomask to be illuminated by the beam, the optical transfer device reciprocating between limits to provide an image field with an object derived by scanning of the photomask, wherein the module comprises telecentric reflective elements disposed to form an image of the light input at the photomask, the module further including means for control of partial coherence of the beam, and movable reflective optics for defining the input image as a scanning beam along the flat format, and including a scanning driver operating in synchronism with the optical transfer system and reciprocating the output image along with the optical transfer system, and wherein the reflective system includes a reflective scanner movable between the limits of the format in synchronism with the optical transfer system.

8. A method of a converting beam from a source of illumination having a selected intensity, wavelength and cross-sectional configuration to a line scanning beam directed through a photomask disposed along a flat format onto a moving optical transfer system, comprising the steps of:
forming the beam from the source into an illuminated arc;
relaying the beam reflectively while forming successive diverging and converging patterns;
introducing partial spatial coherence in the beam when in a diverged state;
forming a variable path in the diverging beam while focusing a terminal section of the beam on the format, wherein a constant length of the beam is maintained and the beam is moved in synchronism with movement of the optical transfer system, and focusing the converging beam at a focal point at the photomask leading to the optical transfer system.

9. A method as set forth in claim 7 above, wherein the input beam is shaped to have a selected etendue, a selected elongated cross-sectional area formed in an arc of illumination, wherein the step of introducing partial spatial coherence maintains the coherence in a selected range, and wherein the beam path length of the converging beam prior to the final focus is selected to cover the full scan dimension of the scanning system.
